(19) United States
(12) Patent Application Publication
(10) Pub. No.: US 2012/0233502 A1
(43) Pub. Date: Sep. 13, 2012

(54) SYSTEM AND METHOD FOR TESTING HIGH-DEFINITION MULTIMEDIA INTERFACE OF COMPUTING DEVICE

(75) Inventors: Hua YUE, Shenzhen City (CN); Hua LI, Shenzhen City (CN); Xiao-Wei FU, Shenzhen City (CN); Bin SUN, Shenzhen City (CN); Tai-Chen WANG, Tu-Cheng (TW); Xue-Hong LIU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/272,234

(22) Filed: Oct. 13, 2011

(30) Foreign Application Priority Data
Mar. 9, 2011 (CN) 201110056345.5

(51) Int. Cl. G06F 11/22

(52) U.S. Cl. 714/27; 714/E11.145

(57) ABSTRACT

In a method for testing a high-definition multimedia interface (HDMI) of a computing device, tests are individually selected and applied to the HDMI. A source code file of the selected test is obtained from a storage system of the computing device. The parameters of the selected test and display resolutions of a display device of the computing device are set. The obtained source code file are executed to apply the selected test to the HDMI according to the set parameters and the display resolutions. After the source code has been executed, the test results are stored.

### BACKGROUND

1. Technical Field

Embodiments of the present disclosure relate generally to interface testing technologies of computing devices, and particularly to a system and method for testing a high-definition multimedia interface (HDMI) of a computing device.

2. Description of Related Art

A high-definition multimedia interface (HDMI) is a compact audio/video interface that is used for transmitting uncompressed digital data. The HDMI is a digital alternative to consumer analog standards, such as radio frequency (RF) coaxial cable, composite video, S-Video, component video, D-Terminal, or video graphics array (VGA). In a test method of the HDMI, test items of the HDMI are manually tested. Such a test method is not only time-consuming but also prone to incomplete testing.

### BRIEF DESCRIPTION OF THE DRAWINGS

FIG. 1 is a block diagram of one embodiment of a computing device including a testing system.

FIG. 2 is a block diagram of functional modules of the testing system of FIG. 1.

FIG. 3 is a flowchart of one embodiment of a method for testing a high-definition multimedia interface (HDMI) of the computing device using the testing system of FIG. 1.

FIG. 4 is an example in the form of a Table of the test items of the HDMI.

FIG. 5 is an illustration of various display resolutions supported by the HDMI.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

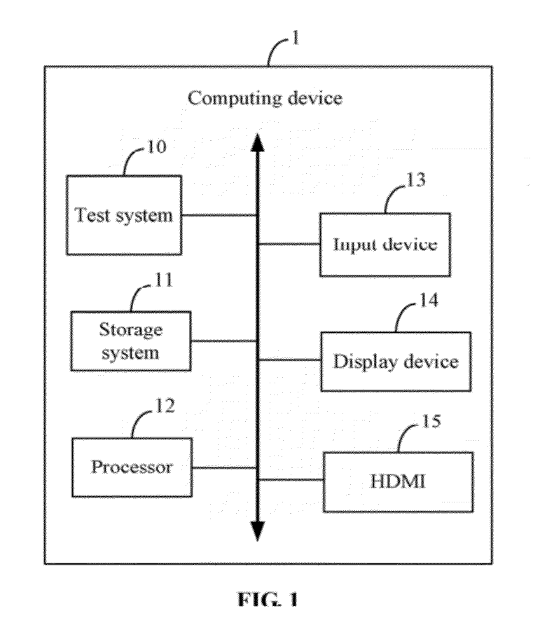

FIG. 1 is a block diagram of one embodiment of a computing device 1 including a testing system 10. The computing device 1 further includes a storage system 11, a processor 12, an input device 13, a display device 14, and a high-definition multimedia interface (HDMI) 15. The display device 14 is electronically connected to the HDMI 15, and displays the test results of the HDMI 15 performed by the testing system 10. In the embodiment, the testing system 10 may include a plurality of software programs in the form of one or more computerized instructions stored in the storage system 11, and executed by the processor 12, to perform operations of the computing device 1 for testing the HDMI 15. The computing device 1 may be, for example, a personal computer or a server. It is understood that FIG. 1 is only one example of the computing device 1 that can include more or fewer components than those shown in the embodiment, or have a different configuration of the various components.

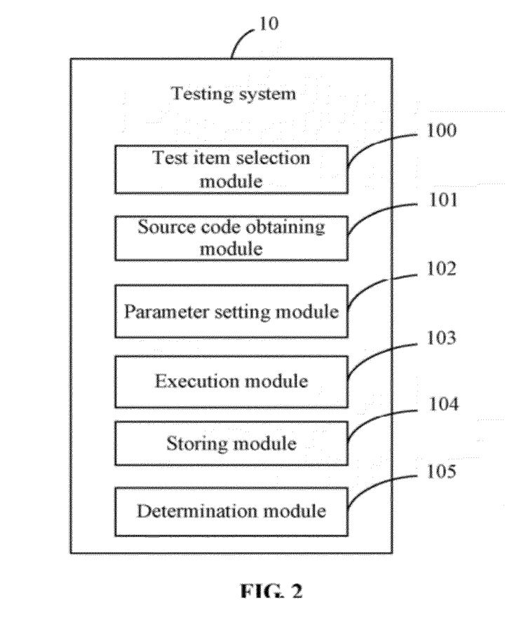

FIG. 2 is a detailed block diagram of one embodiment of functional modules of the testing system 10 of FIG. 1. In the embodiment, the testing system 10 includes a test item selection module 100, a source code obtaining module 101, a parameter setting module 102, an execution module 103, a storing module 104, and a determination module 105. In general, the word “module”, as used herein, refers to logic embodied in hardware or firmware, or to a collection of software instructions, written in a programming language, such as, Java, C, or Assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

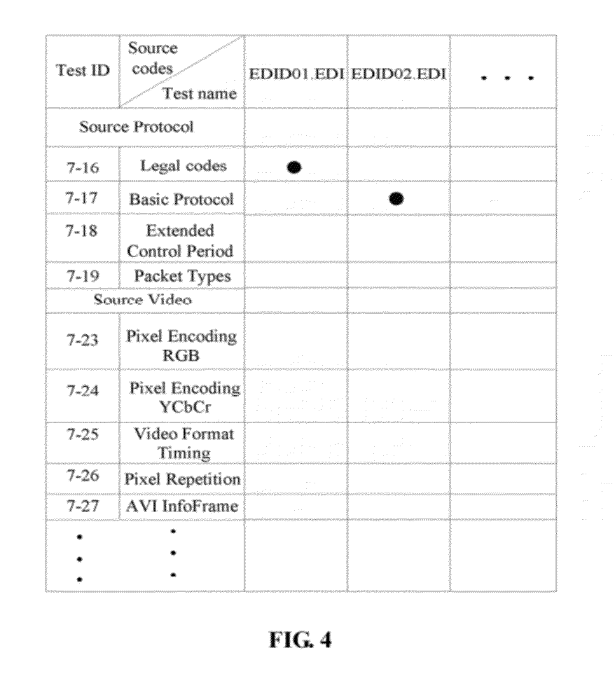

The test item selection module 100 selects one of test items to be tested of the HDMI 15. In the embodiment, the test items includes, for example, “legal codes test”, “basic protocol test”, “extended control period test”, “video format timing test”, “pixel repetition test”, “audio layout test”, and “pixel encoding test”. Each of the test items has a test ID. For example, as shown in FIG. 4, a number of test items of the HDMI are shown in the FIG. 4, the test ID of the “legal codes test” is “7-16”, the test ID of the “basic protocol test” is “7-17”, and the test ID of the “extended control period test” is “7-18”.

The source code obtaining module 101 obtains a source code file of the selected test item from the storage system 11. In the embodiment, the source code file includes a plurality of programmable codes written in a high-level programming language, such as, Java, C, or C++. Each of the test items corresponds to a source code file. For example, the source code file of the legal codes test is “EDID01.EDI”, the source code file of the basic protocol test is “EDID02.EDI”, the source code file of the legal codes test is “EDID01.EDI”,

The parameter setting module 102 sets parameters of the selected test item, and display resolutions of the display device 14 that are supported by the HDMI, such as, 640×480 pixels (p), 720×480p, 720×576p, 1280×720p, or 1920×1080p. In the embodiment, each test item of the HDMI 15 may include one or more parameters. For example, if the selected test item is the “pixel encoding test”, the parameters of the “pixel encoding test” may include, for example, color format and color depth. The color format may be set as RGB (red, green, blue), or YCbCr, and the color depth may be set as 24 bits, 32 bits, or 48 bits.

The execution module 103 executes the obtained source code file (e.g., complies the source code file and then executes the complied data) to apply the test of the selected test item to the HDMI according to the set parameters and the display resolutions.

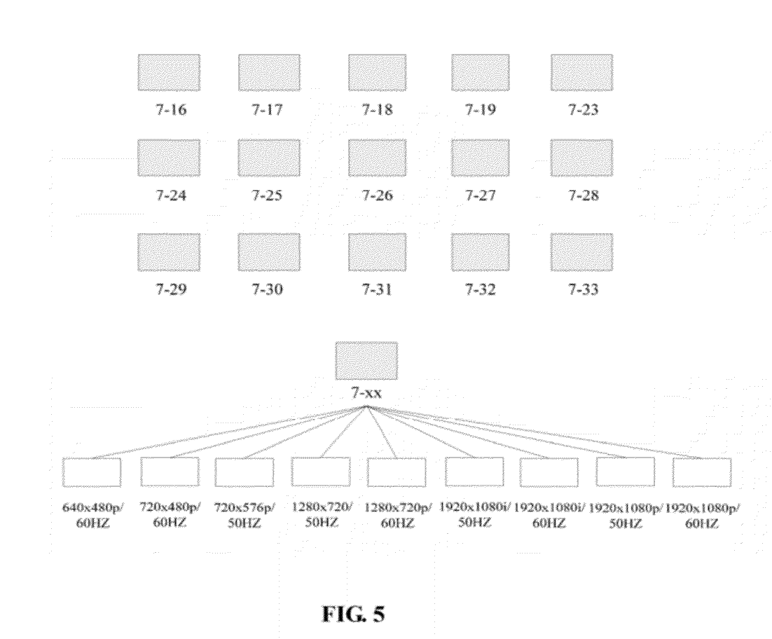

In the embodiment, as shown in FIG. 5, each of the test items may be carried out under different display resolutions. When the source code file is executed, the test results are recorded into a test file, which may be a text file.

The storing module 104 establishes a folder in the storage system 11, and stores the test file into the folder, the folder is named using the test ID of the particular test item.

The determination module 105 determines whether all of the test items of the HDMI 15 have been tested. If any test item of the HDMI 15 has not been tested, the test item selection module 100 selects the next test for the HDMI 15.

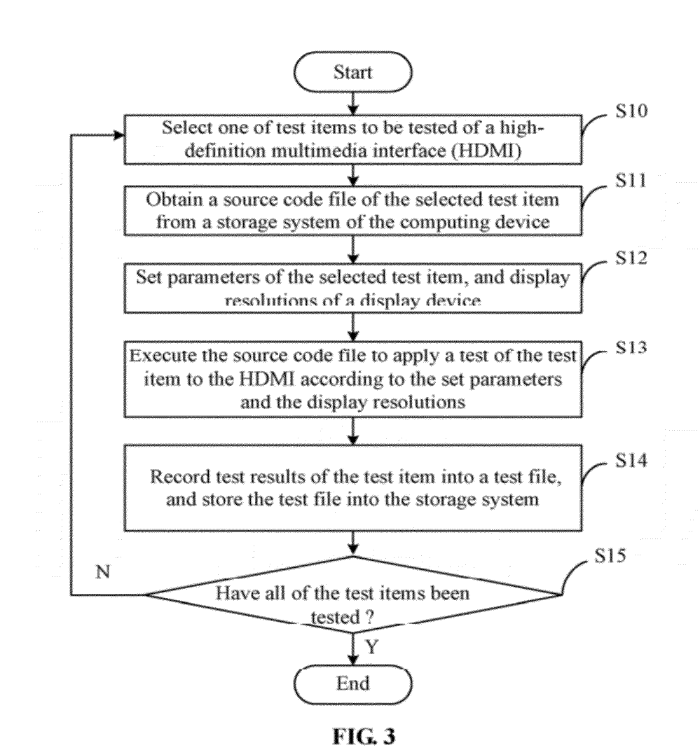

FIG. 3 is a flowchart of one embodiment of a method for testing the HDMI 15 of the computing device 1 using the testing system 10 of FIG. 1. Depending on the embodiment, additional blocks may be added, others removed, and the ordering of the blocks may be changed.

In block S10, the test item selection module 100 selects one of test items to be tested of the HDMI 15. In the embodiment, the possible test items include, for example, “legal codes test”, “basic protocol test”, “extended control period test”, “video format timing test”, “pixel repetition test”, “audio layout test”, and “pixel encoding test”. Each of the test items has its own test ID.

In block S11, the source code obtaining module 101 obtains the source code file of the selected test item from the storage system 11. In the embodiment, each of the test items corresponds to a source code file that includes a plurality of programmable codes.

In block S12, the parameter setting module 102 sets the parameters of the selected test item, and the display resolutions of the display device 14 which are supported by the HDMI 15, such as, 640×480 pixels (640×480p), 720×480p, 720×576p, 1280×720p, or 1920×1080p. In the embodiment, each of the tests may include one or more parameters.

In block S13, the execution module 103 executes the obtained source code file to apply the test of the selected test item to the HDMI 15 according to the set parameters and the display resolutions. In the embodiment, as shown in FIG. 5, each of the test items may be applied based on different display resolutions of the display device 14. When the source code file has been executed, the test results are generated and recorded into a test file with a predefined name, such as a text file.

In block S14, the storing module 104 establishes a folder in the storage system 11, and stores the test file into the folder, the folder is named using the test ID of the selected test item.

In block S15, the determination module 105 determines whether all of the test items of the HDMI 15 have been tested. If any test item has not been tested, block S10 is repeated. If all of the test items have been tested, ends the procedure.

All of the processes described above may be embodied in, and fully automated via, functional code modules executed by one or more general purpose computing devices or processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A computerized-method for testing a high-definition multimedia interface of a computing device, the method comprising:
selecting one of test items of the HDMI;
obtaining a source code file of the selected test item from a storage system of the computing device;
setting parameters of the selected test item, and display resolutions of a display device of the computing device that are supported by the HDMI; and
executing the obtained source code file to apply a test of the selected test item to the HDMI according to the set parameters and the display resolutions;
generating test results of the test item after the obtained source code file is executed;
and storing the test results into the storage system.

2. The method according to claim 1, wherein the storing step comprises:
recording the test results into a test file;
establishing a folder in the storage system; and
storing the test file into the folder.

3. The method according to claim 2, wherein each of the test items of the HDMI has a test ID.

4. The method according to claim 3, wherein the folder is named using the test ID of the selected test item.

5. A computing device, comprising:
a high-definition multimedia interface (HDMI);
a display device electronically connected to the HDMI;
one or more programs stored in a storage system and being executable by at least one processor of the computing device, the one or more programs comprising:
a test item selection module operable to select one of test items of the HDMI;
an source code obtaining module operable to obtain a source code file of the selected test item from the storage system;
a parameter setting module operable to set parameters of the selected test item and display resolutions of the display device that are supported by the HDMI; and
an execution module operable to execute the obtained source code file to apply a test of the selected test item to the HDMI according to the set parameters and the display resolutions, generate test results of the test item after the source code file is executed, and store the test results into the storage system.

6. The computing device according to claim 5, wherein the execution module further operable to record the test results into a test file.

7. The computing device according to claim 6, wherein in the one or more programs further comprises:
a storing module operable to establish a folder in the storage system, and store the test file into the folder.

8. The computing device according to claim 7, wherein each of the test items of the HDMI has a test ID.

9. The computing device according to claim 8, wherein the folder is named using the test ID of the selected test item.

10. A non-transitory storage medium storing a set of instructions, the set of instructions capable of being executed by a processor of a computing device, cause the processor to perform a method for testing a high-definition multimedia interface (HDMI) of the computing device, the method comprising:
selecting one of test items of the HDMI;
obtaining a source code file of the selected test item from a storage system of the computing device;
setting parameters of the selected test item, and display resolutions of a display device of the computing device that are supported by the HDMI; and
executing the obtained source code file to apply a test of the selected test item to the HDMI according to the set parameters and the display resolutions; generating test results of the test item after the source code file is executed; and
storing the test results into the storage system.

11. The non-transitory storage medium according to claim 10, wherein the storing step comprises:
recording the test results into a test file;
establishing a folder in the storage system; and
storing the test file into the folder.

12. The non-transitory storage medium according to claim 11, wherein each of the test items of the HDMI has a test ID.

13. The non-transitory storage medium according to claim 12, wherein the folder is named using the test ID of the selected test item.

14. The non-transitory storage medium according to claim 10, wherein the medium is selected from the group consisting of a hard disk drive, a compact disc, a digital video disc, and a tape drive.
